(19) United States
(12) Patent Application Publication
(10) Pub. No.: US 2014/0365451 A1
(43) Pub. Date: Dec. 11, 2014

(54) METHOD AND SYSTEM FOR CLEANING UP FILES ON A DEVICE

(71) Applicant: BEIJING NETQIN TECHNOLOGY CO., LTD, Beijing (CN)

(72) Inventors: Yaowei Chen, Beijing (CN); Yu Lin, Beijing (CN); Shihong Zou, Beijing (CN)

(21) Appl. No.: 14/130,113

(22) PCT Filed: Mar. 13, 2013
(86) PCT No.: PCT/CN2013/072535

§ 371 Date: Dec. 30, 2013

(30) Foreign Application Priority Data
Mar. 30, 2012 (CN) 201210090087.7

(51) Int. Cl. G06F 17/30

(52) U.S. Cl. CPC G06F 17/3007; G06F 17/30371
USPC 707/692

(57) ABSTRACT

A method and system for cleaning up junk files on a mobile terminal are provided. The method comprises: scanning, by a mobile terminal client, a file system on a local mobile terminal to generate a list of file information; submitting, by the mobile terminal client, to a server side the list of file information; comparing, by the server side, the list of file information submitted by the client with an associated list of file information in a server side database and returning the comparison result; determining a request for cleaning up in the file system on the basis of the comparison result, and performing, by the mobile terminal client, an operation of cleaning up.

The effects of the present invention comprise enabling the timely and effective cleanup of the junk files on the mobile terminal, releasing more storage space, and leaving no junk file in the mobile terminal storage space, while at the same time enabling the greatest extent of prevention of misidentification and accidental deletion of the junk files, thus enabling a user to utilize and maintain storage space resources of the mobile terminals more efficiently, and facilitating the use by the user.

### CROSS-REFERENCE TO RELATED APPLICATION(S)

This application is a U.S. National Phase Application of International Application No. PCT/CN2013/072535, filed on Mar. 13, 2013, entitled “METHOD AND SYSTEM FOR CLEANING UP FILES ON DEVICE,” which claims priority to Chinese Application No. 201210090087.7, filed on Mar. 30, 2012, both of which are incorporated herein by reference in their entirety.

### TECHNICAL FIELD

The present invention relates to a method and a system for cleaning up files on a device, and belongs to the field of computer technology.

### BACKGROUND

With the developing of the mobile communication technologies, a need for functions of a mobile terminal (such as a mobile phone or a tablet computer) increases continuously, and there are more and more various mobile-terminal-based handy applications. Applications on a mobile terminal is continuously replaced or improved to meet one's different needs at different times. Mobile terminals have become a necessary tool used in one's daily works. Activities, such as, storing and editing a file in a mobile terminal, playing a game with a mobile terminal, browsing a web page over the Internet, chatting, or receiving and transmitting an email, are performed more frequently, so that various applications and log files are imported to and/or exported from a mobile terminal frequently. As a result, generation of useless files is inevitable.

Vast useless files among useful ones occupy storage space of a mobile terminal. With the lapse of time, running speed of a mobile terminal is slowed down, and normal operations of other useful files performed by a user will be affected. Though the storage space of the mobile terminal can be expanded, this expansion is limited. Therefore, a critical problem of how to clean up junk files timely and release more storage space to leave no junk files in storage space of a mobile terminal is to be addressed.

There is a method for cleaning up junk files on a mobile phone in prior art. For example, a Chinese Patent Application No. 200810146279.9, entitled “Method for managing files in mobile terminal and mobile terminal”, filed on Aug. 14, 2008, discloses a method for managing files in a mobile terminal, the method comprising steps of: 1) scanning junk files and displaying the junk files obtained by scanning, by the mobile terminal; 2) receiving a request for deleting the junk files from a user, and deleting the junk files requested by the user. According to the above method, the mobile terminal has a junk file scanning function and can display, to the user, the junk files obtained by scanning so that the user can delete some or all of the junk files according to his/her needs. However, this method imposes a high standard with respect to the user, which requires the user to have some knowledge of various file types. Furthermore, there is a problem that the user is required to determine which file(s) is a junk file(s) to be deleted. In this way, a file may be easily misidentified and accidentally deleted.

In the method of the prior art, junk files on a mobile terminal can be scanned and deleted. However, this prior art method requires a user to manually set conditions for scanning, and therefore a file may be easily misidentified and accidentally deleted.

### SUMMARY

The main object of the present invention is to provide a method and a system for cleaning up junk files on a mobile terminal, aiming to address the problem that the prior art method requires a user to manually set conditions for scanning and therefore files may be easily misidentified and accidentally deleted.

The technical solution adopted by the present invention is to provide a method for cleaning up files on a device, the method comprising steps of: a) scanning, by a device client, a file system on a local device to generate a list of file information; b) submitting, by the device client, to a server side the list of file information; c) receiving, on the device, from the server side a comparison result generated by comparing the list of file information submitted by the client and an associated list of file information in a server side database; and d) determining a request for cleaning up in the file system based on the comparison result, and performing, by the device client, an operation of cleaning up.

According to one aspect of the present invention, the device may be a mobile terminal.

According to one aspect of the present invention, the files may be junk files.

According to one aspect of the present invention, the file system may be part or all of files stored in all the storage spaces on the device.

According to one aspect of the present invention, the list of file information may comprise at least one of: characteristic values of the files, and full paths of the files and folders;

The files may comprise at least: applications, and files generated in the processes of installation and usage of the applications.

According to one aspect of the present invention, before the server side compares the list of file information submitted by the client with an associated list of file information in a server side database, the method may further comprise a step of: setting up, by the sever side, the associated list of file information for applications suitable to be used on the device.

According to one aspect of the present invention, the associated list of file information may comprise characteristic values of applications, characteristic values of files generated by the applications, and full paths of files and folders;

The associated list of file information records the relations between the applications and files or folders generated by the applications.

According to one aspect of the present invention, the step c) comprises:

A corresponding application may be found in the associated list of file information according to the characteristic values of the files and the full paths of the files and folders in the list of file information or any combination thereof, and a tag may be added to the corresponding files and folders, the tag indicating the corresponding application.

If the corresponding application is not found in the associated list of file information, a tag may be added to the files and folders, the tag indicating that there is no corresponding application.

According to one aspect of the present invention, the method further comprises: application information indicated in the tag may be compared with the characteristic values of the applications in the list of file information, and the files or folders having no corresponding applications may be found and marked.

According to one aspect of the present invention, the server side may return the comparison result to the local device, and the device may display the comparison result which is a list of file information with marks and tag information.

According to one aspect of the present invention, the step d) may comprise: the request for cleaning up is to select, from the comparison result, the files with marks or the empty folders with marks to be cleaned up, and the device client performs an operation of cleaning up the selected files and empty folders.

According to one aspect of the present invention, before the device client performs an operation of cleaning up, the method further comprises: the device client may choose to clean up automatically or manually.

According to one aspect of the present invention, in the step c), the device client may further compare the list of file information with the associated list of file information in a device database.

A local associated list of file information is stored in the device database.

According to one aspect of the present invention, data in the device database may be downloaded and updated from the server side periodically.

The technical solution adopted by the present invention provides a system for cleaning up files on a device. The system may comprise a device and a server side.

The device comprises a communication module, a file scanning module, a file cleanup module and a data displaying module; the communication module is configured to be used by a user to communicate with the device via the communication module and be used by the device to communicate with the server side via the communication module; the file scanning module is configured to be used by a device client to scan part or all of information in a local device file system in real time to generate a list of file information; the file cleanup module is configured to receive, from the user, a request for cleaning up files in a comparison result file list, and to clean up the selected files; and the data displaying module is configured to provide the user with a display interface and to display comparison result information.

According to one aspect of the present invention, the server side may comprise a communication module, a comparison module and a database, wherein the server side communicates with the device via a network connection, and receives the list of file information submitted by the device client; the communication module is configured to be used by the server side to communicate with the device via the communication module; the comparison module is configured to compare the list of file information submitted by the device client with an associated list of file information in the database to form a comparison result; the database is configured to store the associated list of file information suitable for applications on the device.

According to one aspect of the present invention, the device may further comprise: a file monitoring module, a comparison module and a database;

The file monitoring module is configured to monitor the device running a new application, and to record the associated list of file information; the comparison module is configured to compare the list of file information provided by the file scanning module with the associated list of file information in the database to form a comparison result; and the database is configured to store the associated list of file information generated by the file monitoring module.

The advantageous effect of the present invention is to provide a method and a system for cleaning up junk files on a mobile terminal which enables the timely and effective cleanup of the junk files on the mobile terminal, release more storage space, and leave no junk file in the mobile terminal storage space. Meanwhile it also enables the greatest extent of prevention of misidentification and accidental deletion of the junk files, and it thus enables a user to utilize and maintain storage space resources of the mobile terminals more efficiently, and facilitates the use byte user.

### BRIEF DESCRIPTION OF THE DRAWINGS

For the purpose of illustration of the solutions in the embodiments of the present invention or in the prior art in a clearer manner, the figures to be used in the description of the embodiments or the prior art will be described below briefly. The figures in the following description are merely some embodiments of the present invention and one ordinarily skilled in the art can derive other figures from these figures without any inventive efforts.

FIG. 1 is a flow chart of a method for cleaning up junk files on a mobile terminal, provided by an embodiment of the present invention;

FIG. 2 is a process flow chart of a method for cleaning up junk files on a mobile terminal, provided by an embodiment of the present invention;

FIG. 3 is a flow chart of a comparison method in a method for cleaning up junk files on a mobile terminal, provided by an embodiment of the present invention; and

FIG. 4 is a block diagram of a system for cleaning up junk files on a mobile terminal, provided by an embodiment of the present invention.

### DETAILED DESCRIPTION

In order to make the objects, features and advantages of the embodiments of the present invention easier to be understood, the present invention will be further described in detail hereinafter with reference to the figures and embodiments.

In an embodiment of the present invention, in order to clean up junk files on a mobile terminal timely, the embodiment of the present invention provides a method for cleaning up the junk files on the mobile terminal, the method being implemented with the following solution:

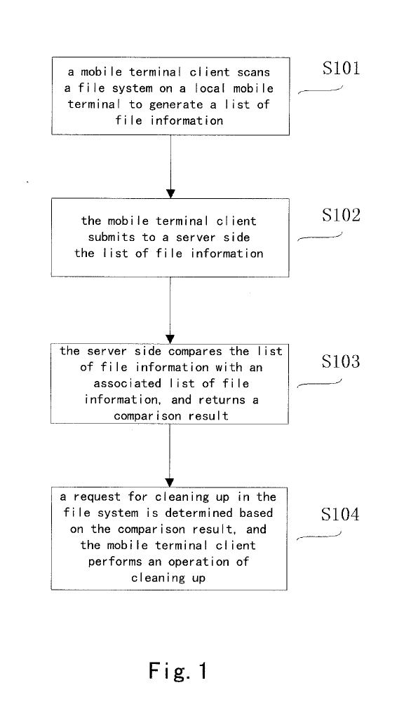

Please refer to FIG. 1, the steps are described as follows:

S101: a mobile terminal client scans a file system on a local mobile terminal to generate a list of file information.

S102: the mobile terminal client submits to a server side the list of file information.

S103: the server side compares the list of file information submitted by the client with an associated list of file information in a server side database, and returns a comparison result.

S104: a request for cleaning up in the file system is determined based on the comparison result, and the mobile terminal client performs an operation of cleaning up.

A detailed description will be provided in conjunction with the specific implementations of the embodiments of the present invention.

The mobile terminal in the embodiments of the present invention, for example, a mobile phone based on the Android system, is introduced in detail. There are many applications required by the user for daily usage, comprising games, chatting softwares or antivirus softwares, etc. Due to different needs of the user in different times, many applications have been installed and uninstalled. Files which were generated by the uninstalled applications are still stored on the mobile phone, and they become junk files which occupy the storage spaces of the mobile phone. The user is required to clean up the junk files timely to make the mobile phone more responsive and fast, and easy to be used.

First, for various application files on mobile phones available on the market, a database is set up at the server side, and the characteristic values of the various applications, the characteristic values of the files generated by the applications, and the full paths of the files and folders are archived and stored to form an associated list of file information. The associated list of file information records the relations between the applications and files or folders generated by the applications.

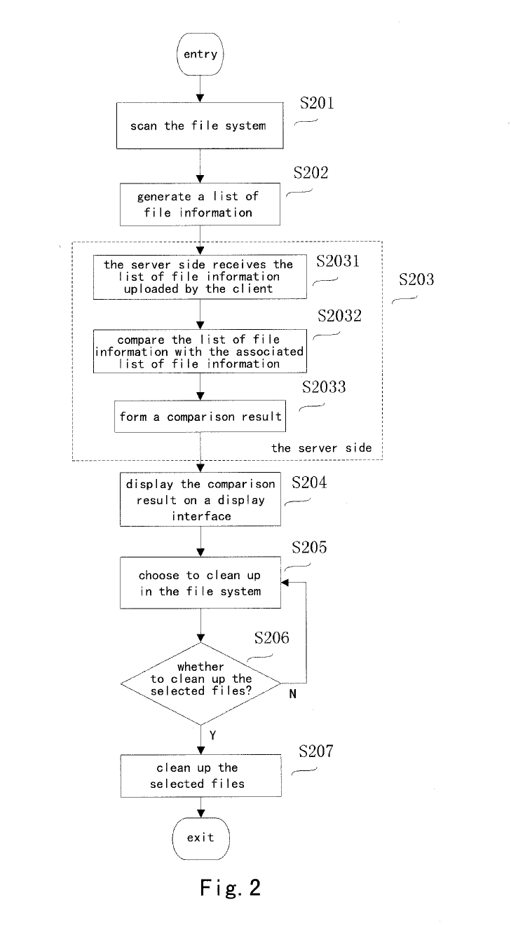

According to an embodiment, referring to FIG. 2, a method for cleaning up junk files on a mobile terminal comprises the following steps:

S201: The mobile terminal client scans the file system, wherein the mobile terminal in this embodiment is a mobile phone.

In this embodiment, the scanning operation performed in the step of “the mobile phone client scans the file system” may be started on a request from the user, or in a time period defined by the user himself/herself, or when an application is uninstalled.

S202: Part or all of the file information on the mobile phone are acquired to generate a list of file information.

The mobile phone client scans the file system, stores the characteristic values of part or all of the files in the file system, the full paths of files and folders for part or all of the files in the file system, or a combination of both, to generate the list of file information.

The file system is part or all of the files stored in all the storage spaces on the mobile terminal. For example, the file system comprises all the files on the mobile phone and in a SD card.

The list of file information comprises at least one of: characteristic values of files, and the full paths of files and folders. A file comprises at least: an application, files generated in the processes of installation and usage of the application, and/or other files. A full path of a file and/or a folder comprises a folder name, a subfolder name, a path and a file name. The characteristic value of a file or the full path of a file and/or a folder corresponds to one file or folder, respectively, wherein the characteristic value of a file may be the name of the file, or a calculated hash value. For example, in the mobile phone using the Android system, the characteristic value of an application is the package name of the APK file or a calculated hash value (the method for calculating a hash value may be selected from SHA-1, MD-5, or similar algorithms), while the characteristic value of a file is the package name of the file or a calculated hash value.

The files generated in the processes of application installation and application usage comprise files generated by the applications in use and files generated by the uninstalled applications. Other files may be all the files other than the applications and the files generated by the applications, comprising the system files of the mobile terminal, as well as the files copied via a removable storage device and the newly created files when the user uses the mobile phone. For example, the other files may be contact data files continuously generated by an instant messenger software on the mobile phone during its usage, files generated by the application which was used by the user but now has been deleted. Files in other forms may be picture files, video files, cached audio files, cached web pages or text files, etc.

S203: the comparison process is to compare the list of file information with the associated list of file information to form a comparison result list.

The associated list of file information comprise at least: characteristic values of applications, characteristic values of files generated by the applications, and the full paths of the files and folders. The associated list of file information records the relations between the applications and files or folders generated by the applications.

In this embodiment, it should be appreciated that, before the comparison, the server side sets up a database at the server side for various application files available on the market suitable for the mobile phones, archives and stores characteristic values of various applications and/or files generated by the applications and the full paths of the files and folders, to generate an associated list of file information.

In an embodiment of the present invention, the specific steps of the comparison process are as follows:

S2031: the mobile phone client submits the list of file information to the server side, and the server side receives the list of file information uploaded by the client.

S2032: the server side compares the list of file information with the associated list of file information in the server side database.

The comparison process comprises:

First, a tag is added to the related files and folders in the list of file information;

At least one of the characteristic values of the files and the full paths of the files and folders in the list of file information is compared with the associated list of file information, and if matched, a corresponding application in the associated list of file information is found and a tag is added to the related files or folders, the tag indicating the information of the corresponding application;

If neither the characteristic values nor the full paths of the files and folders are matched, a tag is added to the files and folders, the tag indicating that there is no corresponding application, wherein the content of the tag may be empty;

Wherein, the full paths of the files and folders comprise the folder names, the subfolder names, the path and the file names, etc.

Then, the related files and folders in the list of file information whose tags indicate that there are corresponding applications are marked;

The files or folders in the list of file information with no corresponding applications are found according to the tag information, and these files and folders are marked, wherein the marking function may be implemented by defining an identification variable.

S2033: the server side generates a comparison result from the comparison, and returns the comparison result to the mobile phone.

For one ordinarily skilled in the art, it should be understood that the above steps may be performed locally at the mobile device when the mobile terminal has enough local computation capability, processing capability, and storage capacity. Meanwhile, the mobile terminal locally stores, in a database, the associated list of file information for various applications, or the contents of the database may be downloaded and updated periodically from the server side.

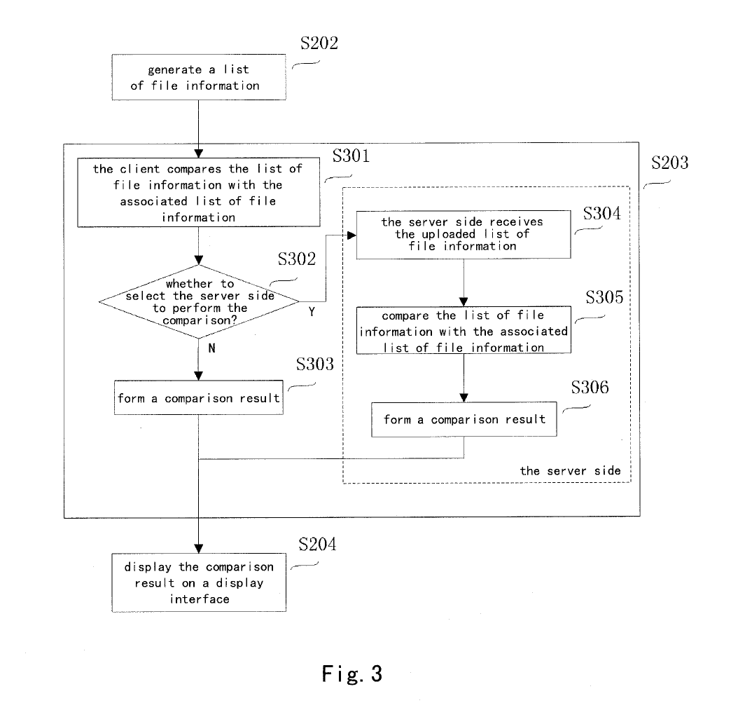

In another embodiment, referring to FIG. 3 for the comparison process, the specific comparison steps are as follows:

S301: the mobile phone client directly compares the list of file information with the associated list of file information in the mobile phone database.

It should be appreciated that, before the comparison, the mobile phone records the characteristic values of the application under the installation and files generated by the application, as well as the full paths of the files and folders. The mobile phone database stores an associated list of mobile phone file information which records the relations between the applications and files or folders generated by the applications.

The comparison process on the mobile phone is same as that on the server side except that the comparison result at the mobile phone may be a comparison result for a part of the files on the mobile phone.

S302: the mobile phone client prompts the user whether to select the server side to perform the comparison.

S303: if the user believes that the mobile phone client comparison has achieved the goal, the user may not select the server side to perform the comparison again, and the comparison result is formed directly.

S304: if the user believes the scope in which the comparison is performed on the mobile phone client is not enough, the user may select the server side to perform the comparison again, and submit the list of file information to the server side. The server side receives the list of file information uploaded by the client.

S305: The server side compares the list of file information with the associated list of file information in the server side database.

S306: The server side forms a comparison result from the comparison, and returns the comparison result to the mobile phone.

In this embodiment, referring to FIG. 2, after the comparison process, the mobile phone performs the following steps:

S204: the mobile phone client displays the result on an interface of the mobile phone after the mobile phone receives the comparison result returned from the server side.

The user views and confirms the comparison result, wherein the comparison result is a list of file information with marks and tag information.

In this embodiment, the unit, in terms of which the comparison is performed, is a file and there are three categories for files in the comparison result list:

The first category: the files with non-empty tag information and without a mark; the non-empty tag information means that the same file information as the characteristic values of the files and the full paths of the files in the list of file information can be found at the server side, and a corresponding application can be found in the associated list of file information at the server side; “without a mark” means that a corresponding application can be found in the list of file information according to the tag information. This category of files comprises the applications in use on the mobile terminal and files generated by the applications, on which files no cleanup operation will be performed by the mobile terminal client.

The second category: the files with non-empty tag information and with a mark; the non-empty tag information means that the same file information as the characteristic values of the files and the full paths of the files in the list of file information can be found at the server side, and a corresponding application can be found in the associated list of file information at the server side; “with a mark” means that a corresponding application cannot be found in the list of file information according to the tag information. This category of files comprises files generated in the installation and usage of the applications which were used on the mobile terminals but now have been deleted, to which files the server side adds a mark when the comparison result is returned.

The third category: the files with empty tag information. If the same file information as the characteristic values of the files and the full paths of the files in the list of file information submitted by the mobile terminal client cannot be found at the server side, the tag content for this category of files is empty in the comparison result list.

S205: the user may choose to perform the cleanup operation on the marked files by viewing the comparison result. In an alternative embodiment, the mobile terminal may automatically choose to perform the cleanup operation on the marked files according to options that the user sets in the mobile terminal in advance.

S206: if the user (or the mobile terminal itself automatically) choose to perform cleaning up, the selected files will be cleaned up, as indicated by S207.

The mobile terminal client cleans up the second category of files mainly, and provides the user with options for the user choosing whether to clean up a certain file of folder. The cleanup comprises an accurate cleanup and a fast cleanup. The accurate cleanup is to clean up the marked files and empty folders, while the fast cleanup is to clean up the marked folders. The mobile terminal client selects the marked files or the empty folders in the comparison result list by default to facilitate the file cleanup operation.

It should be appreciated that, before the cleanup operation, the user may set the mobile terminal client to perform an automatic cleanup or a manual cleanup. If the user chooses the automatic cleanup, the mobile terminal client provides a cleanup prompt, such as, “8 marked files are selected, cleaning up them all?” The mobile terminal client performs a cleanup operation on the files or empty folders selected by default after the confirmation from the user. If the user chooses the manual cleanup, the user needs to manually select, in the comparison result, the files or folders with tags and marks to perform a cleanup. The mobile terminal client performs a cleanup operation on the selected files and folders after the request for cleaning up is received from the user.

The cleanup operations selected by the user may be: delete, compress-and-store, or move to the recycle bin, etc. The mobile terminal client will perform corresponding operations on the files according to the selection made by the user and prompt the user with the operation result.

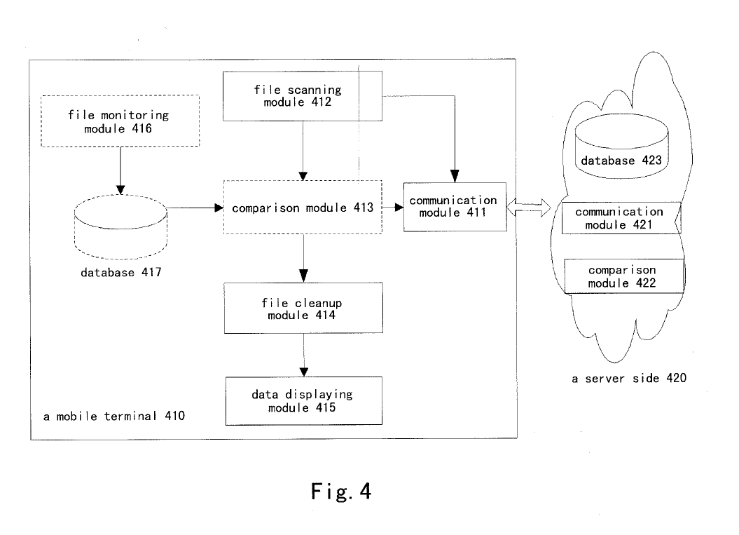

Referring to FIG. 4, an embodiment of the present invention also provides a system for cleaning up junk files on a mobile terminal, the system comprising: a mobile terminal 410 and a server side 420.

The mobile terminal comprises a communication module 411, a file scanning module 412, a file cleanup module 414 and a data displaying module 415;

The communication module 411 is configured to be used by a user to communicate with the mobile terminal 410 via the communication module 411, and to be used by the mobile terminal 410 to communicate with the server side 420 via the communication module 411;

The file scanning module 412 is configured to be used by the mobile terminal 410 to scan part or all of the information in a local mobile terminal file system in real time to generate a list of file information;

The file cleanup module 414 is configured to receive, from the user, a request for cleaning up files in a comparison result file list; and

The data displaying module 415 is configured to provide the user with a display interface and to display the comparison result information.

According to an embodiment of the present invention, the server side 420 comprises a communication module 421, a comparison module 422 and a database 423;

The server side 420 communicates with the mobile terminal 410 via a network connection, and receives the list of file information submitted by a client on the mobile terminal 410;

The communication module 421 is configured to be used by the server side 420 to communicate with the mobile terminal 410 via the communication module 421;

The comparison module 422 is configured to compare the list of file information submitted by the client on the mobile terminal 410 with an associated list of file information in the database to form a comparison result;

The database 423 is configured to store the associated list of file information suitable for the applications on the mobile terminal 410.

According to another embodiment of the present invention, referring to FIG. 4, the mobile terminal 410 may further comprise: a file monitoring module 416, a comparison module 413 and a database 417;

The file monitoring module 416 is configured to monitor the mobile terminal 410 running a new application, and to record the associated list of file information;

The comparison module 413 is configured to compare the list of file information provided by the file scanning module 412 with the associated list of file information in the database 417 to form a comparison result; and

The database 417 is configured to store the associated list of file information generated by the file monitoring module 416.

Additionally, the scope of the method, apparatus and system disclosed in the above embodiments of the present invention is not limited to the mobile terminal. In particular, they can also be applied to communication devices such as fixed terminals (desktop computers, set-top boxes, residential intelligent gateways, etc.), network side devices (routers, switches, access points, base stations, radio network controllers (RNC)), etc. In fact, the present invention can be applied as long as the device with junk files to be cleaned up can communicate with a server. Furthermore, even if the user does not wish connecting to the server, a local comparison can be performed at the device locally according to the associated list of file information in the device database, and corresponding cleanup operations can be performed, as discussed above.

Additionally, the scope of the method, apparatus and system disclosed in the above embodiments of the present invention is not limited to junk file cleanup. In particular, they can also be applied to clean up any type of files, such as files infected by a virus, various data and programs prohibited by the laws and regulations, etc. In fact, any file at the terminal side can be cleaned up by the present invention as long as the file to be cleaned up can be recorded in the associated list of file information in the database of the server side (or the terminal).

The descriptions of the above embodiments are used in assisting the understand of the method of the present invention and the essential ideas thereof, and they are only the preferred implementation of the present invention. However, the scope of the present invention is not limited thereto. The changes and alternatives, that come from the scope of the present invention and are obvious to one ordinarily skilled in the art, should be embraced by the scope of the present invention. Therefore, the description should not be construed as a limitation to the present invention. The scope of the present invention should be defined by the scope of the claims.

1. A method for cleaning up files on a device, characterized in that the method comprises steps of:
a) scanning, by a device client, a file system on a local device to generate a list of file information;
b) submitting, by the device client, to a server side the list of file information;
c) receiving, on the device, from the server side a comparison result generated by comparing the list of file information submitted by the client and an associated list of file information in a server side database;
d) determining a request for cleaning up in the file system based on the comparison result, and performing, by the device client, an operation of cleaning up.

2. The method for cleaning up files on a device of claim 1, characterized in that: the device is a mobile terminal.

3. The method for cleaning up files on a device of claim 1, characterized in that: the files are junk files.

4. The method for cleaning up files on a device of claim 1, characterized in that: the file system is part or all of files stored in all the storage spaces on the device.

5. The method for cleaning up files on a device of claim 1, characterized in that: the list of file information comprises at least one of:
characteristic values of the files, and
the full paths of the files and folders,
wherein the files at least comprise: applications, and files generated in the processes of installation and usage of the applications.

6. The method for cleaning up files on a device of claim 1, characterized in that: before the server side compares the list of file information submitted by the client with an associated list of file information in a server side database, the method further comprises a step of: setting up, by the sever side, the associated list of file information for applications suitable to be used on the device.

7. The method for cleaning up files on a device of claim 1, characterized in that: the associated list of file information comprises:
characteristic values of applications,
characteristic values of files generated by the applications, and full paths of files and folders,
wherein the associated list of file information records the relations between the applications and files or folders generated by the applications.

8. The method for cleaning up files on a device of claim 7, characterized in that: the step c) comprises:
finding a corresponding application in the associated list of file information according to the characteristic values of the files and the full paths of the files and folders in the list of file information or any combination thereof, and adding a tag to the corresponding files and folders, the tag indicating the corresponding application;
adding a tag to the files and folders if the corresponding application is not found in the associated list of file information, the tag indicating there is no corresponding application.

9. The method for cleaning up files on a device of claim 8, characterized in that: the method further comprises: comparing application information indicated in the tag with the characteristic values of the applications in the list of file information, and finding and marking the files or folders having no corresponding applications.

10. The method for cleaning up files on a device of claim 9, characterized in that: returning, by the server side, the comparison result to the local device, and displaying, by the device, the comparison result which is a list of file information with marks and tag information.

11. The method for cleaning up files on a device of claim 9, characterized in that: the step d) comprises: the request for cleaning up is to select, from the comparison result, the files with marks or the empty folders with marks to be cleaned up, and the device client performs an operation of cleaning up the selected files and empty folders

12. The method for cleaning up files on a device of claim 1, characterized in that: before the device client performs an operation of cleaning up, the method further comprises: choosing, by the device client, to clean up automatically or manually.

13. The method for cleaning up files on a device of claim 1, characterized in that: in the step c), further comparing, by the device client, the list of file information with the associated list of file information in a device database;
wherein a local associated list of file information is stored in the device database.

14. The method for cleaning up files on a device of claim 13, characterized in that: data in the device database is downloaded and updated from the server side periodically.

15. A system for cleaning up files on a device, characterized in that: the system comprises a device and a server side;
the device comprises a communication module, a file scanning module, a file cleanup module and a data displaying module;
the communication module is configured to be used by a user to communicate with the device via the communication module and be used by the device to communicate with the server side via the communication module;
the file scanning module is configured to be used by a device client to scan part or all of information in a local device file system in real time to generate a list of file information;
the file cleanup module is configured to receive, from the user, a request for cleaning up files in a comparison result file list, and to clean up the selected files; and
the data displaying module is configured to provide the user with a display interface, and to display comparison result information.

16. The system for cleaning up files on a device of claim 15, characterized in that: the server side comprises a communication module, a comparison module and a database, wherein the server side communicates with the device via a network connection, and receives the list of file information submitted by the device client;
the communication module is configured to be used by the server side to communicate with the device via the communication module;
the comparison module is configured to compare the list of file information submitted by the device client with an associated list of file information in the database to form a comparison result; and
the database is configured to store the associated list of file information suitable for applications on the device.

17. The system for cleaning up files on a device of claim 15, characterized in that: the device further comprises: a file monitoring module, a comparison module and a database;
the file monitoring module is configured to monitor the device running a new application, and to record the associated list of file information;
the comparison module is configured to compare the list of file information provided by the file scanning module with the associated list of file information in the database to form a comparison result; and
the database is configured to store the associated list of file information generated by the file monitoring module.
